(19) United States
(12) Patent Application Publication
(10) Pub. No.: US 2018/0373425 A1
(43) Pub. Date: Dec. 27, 2018

(54) KEYBOARD APPLICATION FOR DEVICE ACCESS SOFTWARE

(71) Applicant: ENDRESS+HAUSER PROCESS SOLUTIONS AG, Reinach (CH)

(72) Inventors: Michael Mayer, Oberwil (CH); Werner Luber, Alisschwil (CH); Ingomar Sotriffer, Gundelfingen (DE)

(21) Appl. No.: 15/775,777

(22) PCT Filed: Oct. 19, 2016
(86) PCT No.: PCT/EP2016/075095

§ 371 Date: May 11, 2018

(30) Foreign Application Priority Data
Nov. 13, 2015 (DE) 10 2015 119 609.3

(51) Int. Cl. G06F 3/0488; G06F 3/0482

(52) U.S. Cl. CPC G06F 3/04886; G06F 3/0482

(57) ABSTRACT

A method for registering an input into the user interface of a driver is described, wherein the driver is integrated into a device access software, with which components of a fieldbus system can be accessed. The device access software includes a keyboard application for display of a virtual keyboard. The method comprises, when the user selects an input field of the user interface of the driver, receiving by the keyboard application of information provided by the driver concerning the type of input required by the input field. Furthermore, the method comprises matching the virtual keyboard displayed by the keyboard application corresponding to the information obtained from the driver concerning the type of input required, and registering the input of the user.

The invention relates to a method for registering an input into the user interface of a driver, wherein the driver is integrated into a device access software, as well as to a keyboard application for a device access software. Furthermore, the invention relates to a device access software, which is installed in a host and with which components of a fieldbus system can be accessed.

In automation technology, field devices are often applied, which serve for registering and/or influencing process variables. Examples of such field devices are fill level measuring devices, mass flow measuring devices, pressure- and temperature measuring devices, etc., which as sensors register the corresponding process variables, fill level, flow, pressure, and temperature.

Parametering, configuration and state monitoring of the field devices of a fieldbus system occur, as a rule, by means of a device access software installed in a host. As a rule, the device access software includes a plurality of drivers, with which the components of the fieldbus system can be accessed. Via the user interfaces of the drivers integrated into the device access software, the user can from the host make inputs and set or change parameter values. The device access software is frequently installed in mobile devices, for example, in tablet-computers, mobile telephones or PDAs. For registering the user input, there is displayed on the touch display of these devices a virtual keyboard, via which a user can provide input into corresponding input fields of the user interface.

It is, consequently, an object of the invention to make the input of a user into a user interface of a driver, which is integrated into a device access software, comfortably configured and matched to the requirements of mobile devices.

This object is achieved by the features set forth in claims 1, 12 and 15.

Advantageous further developments of the invention are set forth in the dependent claims.

A method corresponding to the forms of embodiment of the invention serves for registering an input into a user interface of a driver, wherein the driver is integrated into a device access software, with which components of a fieldbus system can be accessed. The device access software includes a keyboard application for display of a virtual keyboard. The method includes, when the user selects an input field of the user interface of the driver, receiving by the keyboard application of information provided by the driver concerning the type of input required by the input field. Furthermore, the method includes conforming the virtual keyboard displayed by the keyboard application corresponding to the information obtained from the driver concerning the type of input required, and registering the input of the user.

Since information provided by the driver concerning the type of input required by the input field is received by the keyboard application, the virtual keyboard displayed by the keyboard application can be matched to the required input. For example, only those input keys are displayed, which are required for the particular input. When a numerical input is required, for example, only a keyboard in the form of a numerical keypad is displayed. This has the advantage that the display of the virtual keyboard consumes significantly less space on the display than previously. The displays of mobile devices are, most often, not very large, and, thus, it helps when the virtual keyboard only includes the input keys really required for the input. When, for example, only the numerical input field and not the complete alphanumeric input keyboard is displayed on the display, then space is saved and, as a result, the input is clearer for the user.

A further advantage is that the input is also more comfortable for the user, because only the really required input keys are displayed. Moreover, the probability of error in the case of inputs by the user is lessened, because the user receives displayed from the outset a virtual keyboard matched and limited to the required input keys, so that the opportunity for defective inputs is lessened. Thus, options for wrong inputs are not presented to the user.

Advantageously, the inputs required by an input field in the user interface of a driver are described e.g. by means of regular expressions. With regular expressions, it is possible in standardized manner to provide specifications regarding the type of input, the allowed input keys and value ranges and the format of the required input.

A device access software corresponding to the forms of embodiment of the invention is installed in a host, wherein components of a fieldbus system can be accessed with the device access software. Integrated into the device access software are one or more drivers, wherein each driver is provided for accessing a component of the fieldbus system. The device access software includes a keyboard application. The keyboard application is designed to receive from the driver information concerning the type of input required from an input field of the user interface of a driver, when a user selects the input field of the user interface of the respective driver, and to match a display of a virtual keyboard corresponding to the information obtained from the driver concerning the type of input required.

In the case of this device access software, the keyboard application is integrated into the device access software. In this way, an opportunity is presented to match the displayed virtual keyboard to the inputs required by the particular input field of a user interface of a driver.

The invention will now be explained in greater detail based on examples of embodiments illustrated in the drawing. The figures of the drawing show as follows:

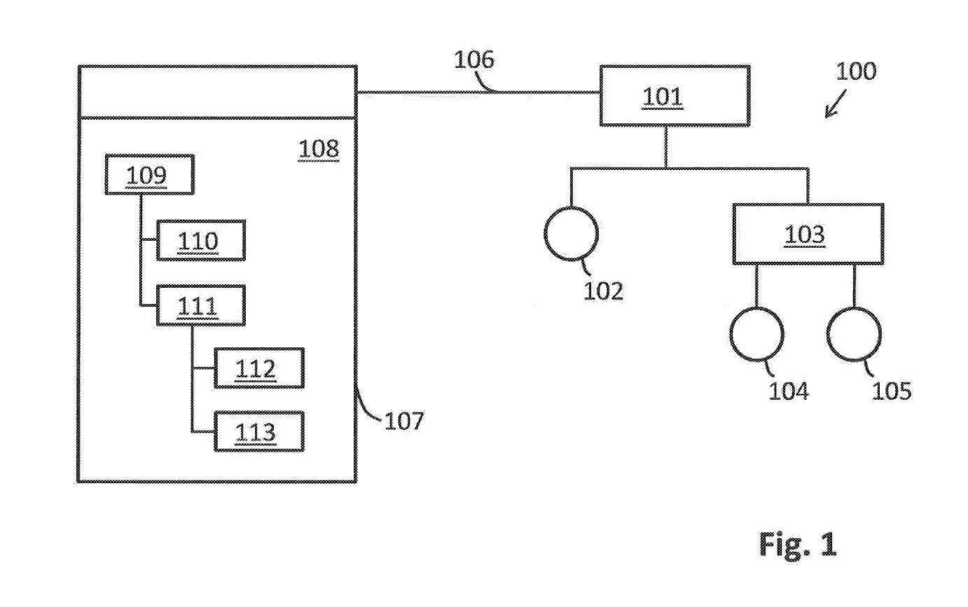

FIG. 1 a fieldbus system together with an associated device access software;

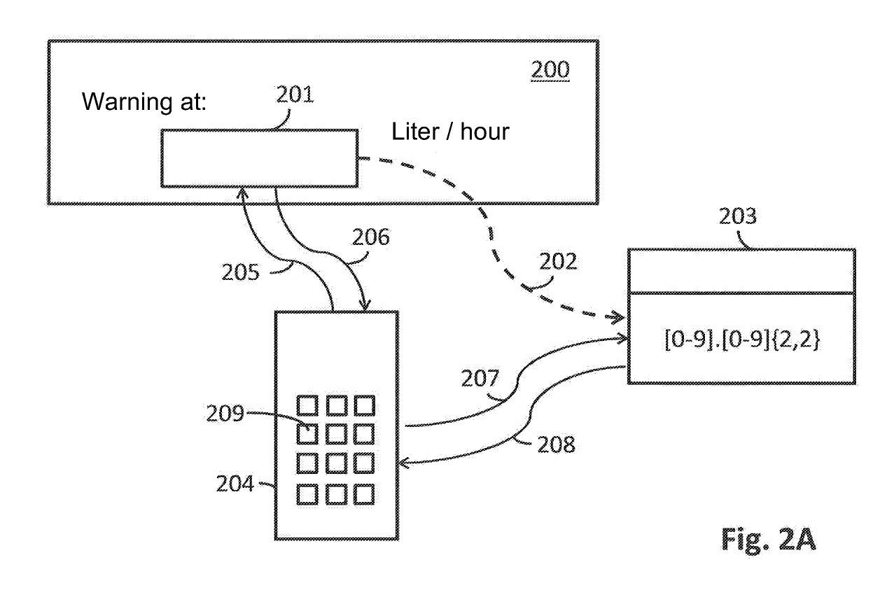

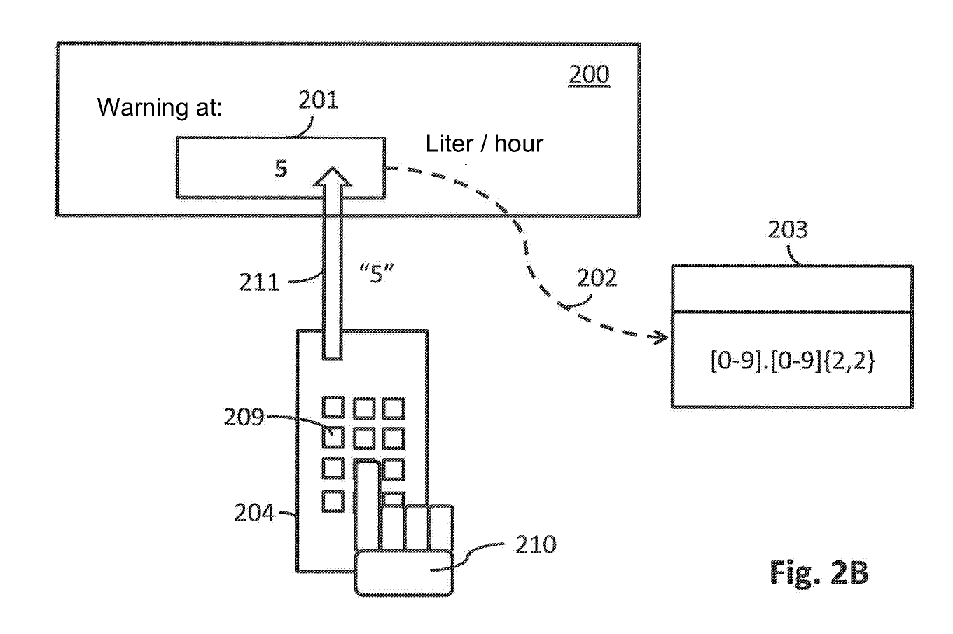

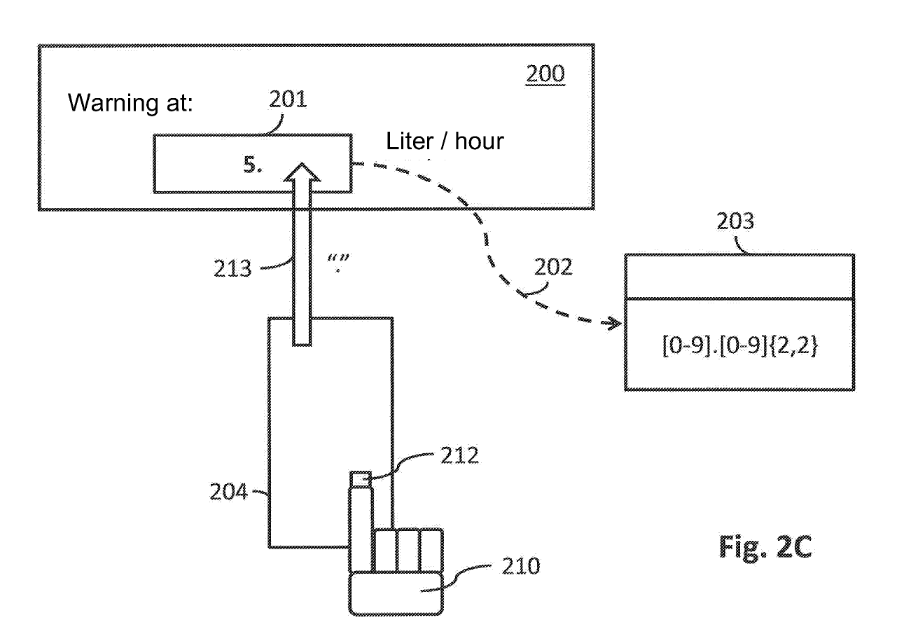

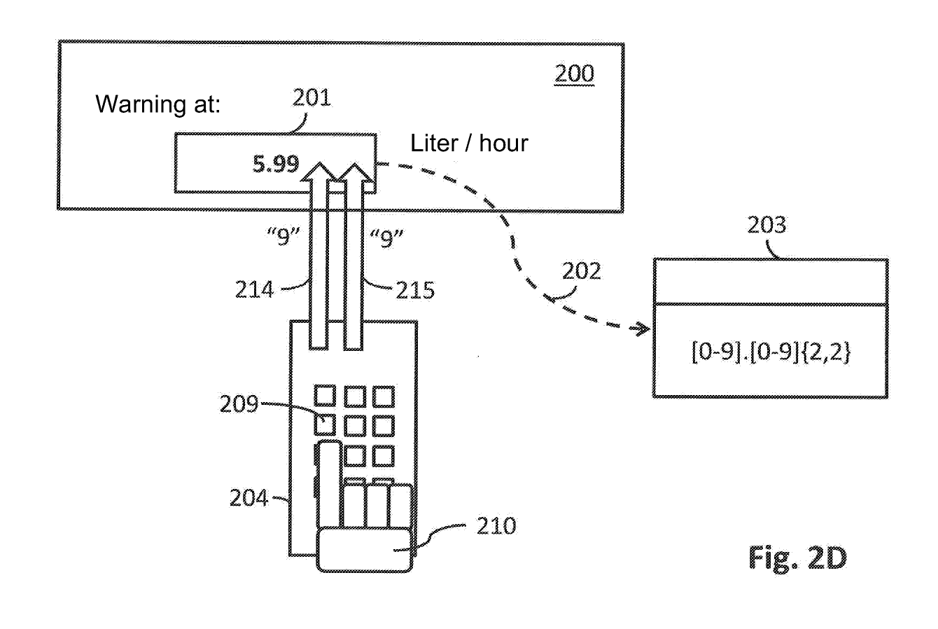

FIG. 2A the transfer of a regular expression from a DTM to the keyboard application;

FIG. 2B the input of a first digit of the required limit value;

FIG. 2C the input of a separator for the required limit value;

FIG. 2D the input of the first and second digits after the separator;

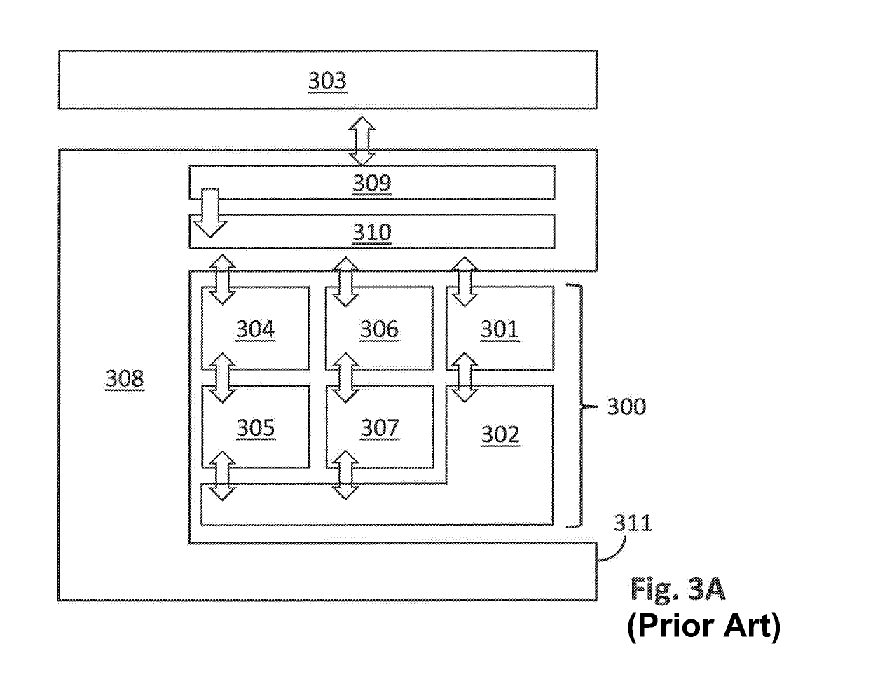

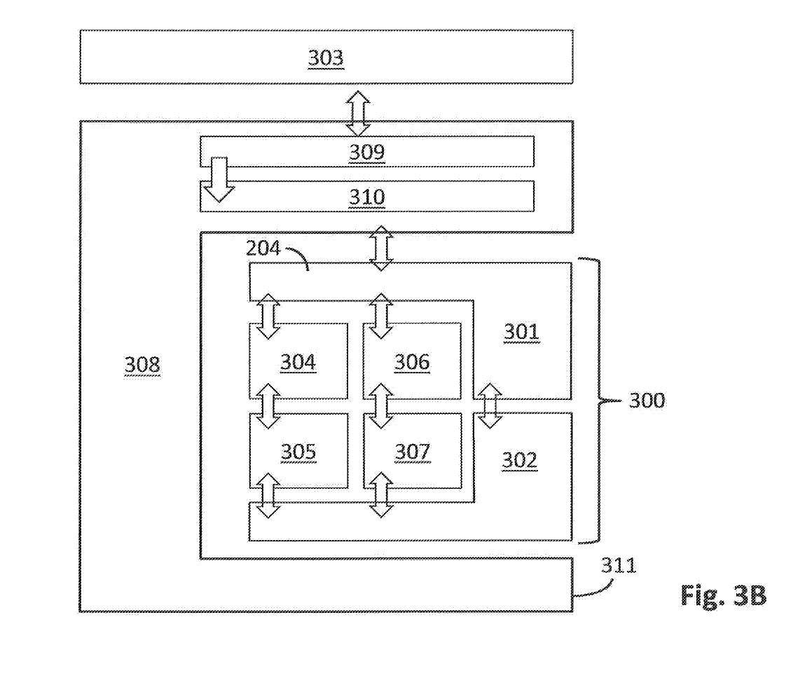

FIG. 3A an overview concerning the different software components of the state of the art present in the host;

FIG. 3B an overview concerning the software components present in the host, wherein the keyboard application is also present; and

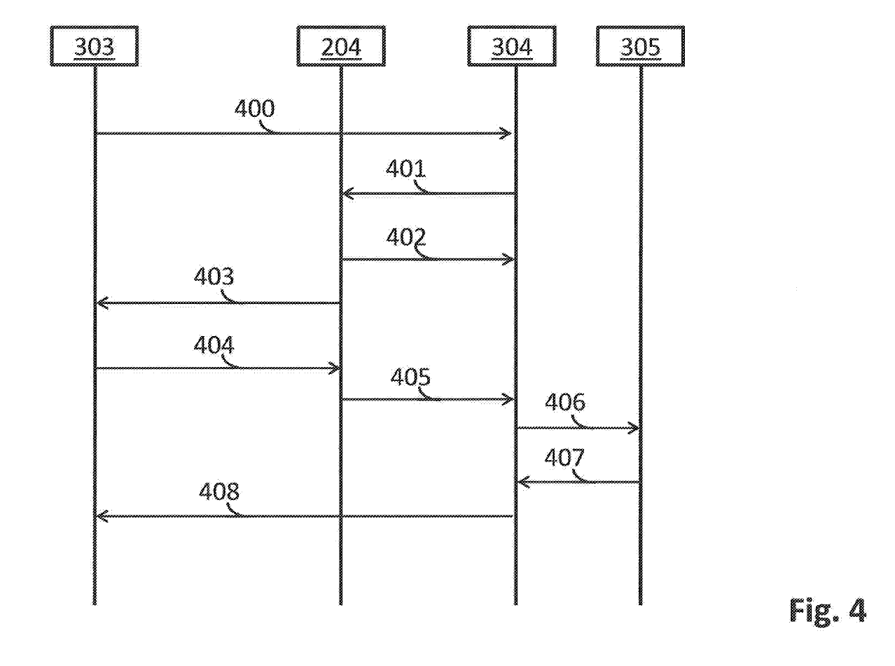

FIG. 4 the communication steps in the case of use of a keyboard application of the invention.

FIG. 1 shows a fieldbus system 100 with multiple, hierarchically arranged, fieldbus segments. The fieldbus system 100 includes a field access device 101, a field device 102 as well as a gateway 103. Connected to the gateway 103 are the two additional field devices 104, 105.

Connected to the field access device 101 via an Ethernet connection 106 is a host 107, in which a device access software 108 is installed. Via the device access software 108, the components of the fieldbus system 100 are configured and parametered by the host 107. Especially, using the device access software 108, the parameters of the different components of the fieldbus system 100 can be read-out, shown and changed. Moreover, the device access software 108 enables a state monitoring (condition monitoring) of the components of the fieldbus system 100. The data exchange required for these tasks is, as a rule, conducted via the so-called acyclic data traffic.

In order to be able to correctly access the different components of the fieldbus system 100, the device access software 108 requires information concerning the properties and parameters of the field devices, gateway, remote I/Os, etc. of the fieldbus system 100. This information is provided by the manufacturers of the different devices, as a rule, in the form of device description files or device drivers. For device description for acyclic data exchange in the case of the fieldbus protocols, Profibus-DP, Profibus-PA, Fieldbus Foundation and HART, device descriptions according to the standards, DD (Device Description), EDD (Enhanced Device Description), DTM (Device Type Manager) as well as FDI Device Packages are used. Especially, in the case of the standards EDD and DTM, supplementally to device parameters, device functionality and address space occupation, also graphic features and graphical user interfaces are predetermined, which facilitates the parametering and configuring of the respective field device. For producing these graphical interfaces in the standard, EDD, particular graphic commands are provided, which are executed in the manner of an interpreter language.

In the standard FDT/DTM, an executable file is provided, which is referred to as a DTM (Device Type Manager). This DTM includes also the mentioned graphic features. The different DTMs for the different components of the fieldbus system are integrated into a shared FDT-frame application, wherein FDT stands for “Field Device Tool”. In this way, a shared frame application is provided, into which the DTMs for different devices and from different manufacturers can be integrated.

The FDT-standard is recently being increasingly supplemented and eventually possibly replaced by the standard, FDI Device Packages.

Besides the previously discussed fieldbus protocols, Profibus, Fieldbus Foundation and HART, the so-called industrial Ethernet protocols are becoming increasingly important, to which, among others, the fieldbus protocols, EtherNet/IP, ProfiNet and EtherCAT, belong.

In the case of the fieldbus protocol EtherNet/IP, a device description file corresponding to the standard EDS (Electronic Data Sheet) is provided for description both of the cyclic as well as also of the acyclic data exchange.

In the example of FIG. 1, the device access software 108 is an FDT-frame application, into which a number of different device DTMs, gateway DTMs and communication DTMs are integrated for description of the fieldbus system 100. At the uppermost position of the DTM-hierarchy is the communication DTM 109. The communication DTM 109 is associated with the field access device 101 and communicates with this via the Ethernet connection 106. The communication DTM 109 represents, in certain respects, the external interface of the device access software 108. All in- and outgoing data traffic is guided via the communication DTM 109.

The device DTM 110 is arranged in the DTM-hierarchy below the communication DTM 109 and forms the functionality of the field device 102. In the plane below the communication DTM 109, there is arranged, moreover, a gateway DTM 111, which is associated with the gateway 103. Via the gateway DTM 111, the gateway 103 can be parametered and configured. Beneath the gateway DTM 111 in the DTM-hierarchy are arranged two device DTMs 112, 113. The device DTM 112 forms the functionality of the field device 104, and the device DTM 113 forms the functionality of the field device 105.

When the device access software 108, thus, for example, an FDT-frame application with a plurality of DTMs integrated therein, runs on a conventional PC, then, after clicking on an input field, the required keyboard inputs can be input by means of a conventional keyboard. In order to enable a comfortable on-site parametering, the device access software 108 is, however, increasingly installed also on mobile end devices, tablets, etc., which do not have a conventional keyboard. In the case of such devices, the inputs into the input fields provided by a DTM user interface occur via a virtual keyboard. Desired values are input by pressing corresponding contact areas on the touch screen.

In the solutions of the state of the art, this virtual keyboard was provided by the operating system, for example, the Windows operating system. As soon as a user tapped a certain input field, the user was displayed a standardized virtual keyboard, with which the user could make the desired inputs. After confirming the input, for example, by pressing the “return” key, the actuated input could be reviewed in a following step. For example, it was checked whether or not the input values were within predetermined range limits.

In the solution described here, there is integrated into the device access software a keyboard application of the invention, which provides the virtual keyboard required for inputs into the input fields. After tapping on an input field, a standard keyboard, such as previously provided by the operating system, is then no longer displayed, but, instead, a virtual keyboard provided by the keyboard application of the invention in the device access software. This offers various advantages. One advantage is that the displayed virtual keyboard can be matched to the data expected by the particular input field. In this way, wrong inputs by the user can be prevented from the outset. Moreover, the displayed virtual keyboard can also be continually matched in the course of the input to the expected input values, for example, by fading possible input keys in or out, as the case may be.

FIG. 2A shows how information concerning the type, format and value range of the expected input are transferred from a DTM to the keyboard application of the invention. For this, FIG. 2A shows a DTM user interface 200, which is presented on the screen. Provided within the DTM user interface 200 is an input field 201. In this input field 201, in the case of the illustrated example, an upper limit value for the flow should be input, and, indeed, in liter per hour. In the case of exceeding this upper limit value, then a warning is displayed.

The upper limit value for the flow is a decimal number in the format “x.xx” with a valid value range of 0.00 to 9.99 liter per hour. There is then the task of transmitting this specification for the input expected in the input field 201 from the DTM to the keyboard application. For this in the case of Microsoft Windows interfaces, a standard concept is provided, in accordance with which a corresponding attribute can be associated with an input field. The connection between the input field and the associated attribute is, in such case, produced by means of a pointer, which points to a data structure associated with the input field. In the example of FIG. 2A, there is stored for the input field 201 a pointer 202, which points to a data structure 203. In this data structure 203, specifications can be made for the type of expected input as well as for the format and for the value range of the expected input. These specifications can then be read-out and used by the keyboard application 204.

The description of type, format and value range of the expected input can advantageously occur with the assistance of a so-called “regular expression”. The terminology, “regular expression”, abbreviated “RegExp” or “RegEx”, means in informatics an expression, which serves for description of ranges of characters with the assistance of certain syntactic rules. Regular expressions are used in computer programming for diverse problem solutions, especially when of concern is to process strings, to test them or to find something in them. Besides being implemented in many programming languages, many text editors make use of regular expressions, for example, for searching and replacing.

In the present example, a regular expression is used to describe that expected as input is a numerical input of format “x.xx” with a valid value range of 0.00 to 9.99. The regular expression becomes 10-91[0-9]{2,2}. This regular expression means that, as first reference character, a reference character from 0 to 9 is expected, which is then followed by a separator in the form of a decimal point, “.”. The expression “{2,2}” means that, after the decimal point, at least two and a maximum of two decimal fraction digits are expected, wherein the expression “[0-9]” means that the valid range for these two numbers is from 0 to 9.

The interaction between the DTM 200 and the keyboard application 204 of the invention, which is implemented as part of the device access software 108, will now be described in greater detail. It is assumed that the user taps on the screen, on which the DTM user interface 200 is presented, on the input field 201. By tapping of the input field 201, firstly, the DTM user interface is addressed, and from there the keyboard application 204 is invoked. The keyboard application 204 checks in step 205, whether for the input field 201 a supplemental attribute is stored, which can be accessed by means of a pointer. Thereupon, in step 206, the keyboard application 204 is informed by the DTM 200 that there is an attribute for input field 201, and the pointer 202 belonging to this attribute is transmitted to the keyboard application 204. In the thereon following step 207, the keyboard application 204 accesses the data structure 203 by means of the pointer 202. In step 208, the data structure 203 with the therein contained, regular expression “[0-9].[0-9]{2,2}” is downloaded by the keyboard application 204 and is now available in the keyboard application 204. In this way, the keyboard application 204 knows, now, which type of input is required by the input field 201. Especially, the keyboard application 204 knows that only numerical inputs are permitted in the input field 201, wherein the format “x.xx” must be maintained, and wherein the allowable value range extends from 0.00 to 9.99. From this regular expression, the keyboard application 204 decides, which virtual input keys should be displayed. In this case, the virtual keyboard displayed is then in the form of the numerical keypad 209.

FIG. 2B shows how the user 210 keys the first digit in. The user 210 presses, for example, on the input key “5” of the numerical keypad 209. This input is in step 211 transferred from the keyboard application 204 to the input field 201 and adopted by it. The digit “5” is then displayed in the input field 201. On the part of the keyboard application 204, the format “x.xx” of the expected input is known from the regular expression. On the part of the keyboard application 204, it is, consequently, known that next the input of the separator in the form of the decimal point “.” is required. As in shown FIG. 2C, the displayed keyboard is accordingly matched. Now, only the “.” key 212 is displayed, all other keys are faded out. The user 210 now taps the “.” key 212. This input is sent in step 213 to the input field 201 and adopted by it. The input field 201 now displays “5.”.

On the part of the keyboard application 204, it is recognizable from the regular expression that, next, two numbers must be input. As shown in FIG. 2D, the virtual keyboard is now changed such that in the end all digit keys are faded in. The user 210 now enters via the numerical keypad 209 the first digit after the separator, for example, the digit “9”. The input is transferred in step 214 to the input field 201 and adopted by the input field. Now, the input field 201 displays “5.9”. Thereupon, the user enters via the numerical keyboard 209 the second digit after the separator, for example, another “9”. This digit is transferred in step 215 to the input field 201 and adopted by the input field 201. At the end, the valid value “5.99” is displayed in the input field 201. Within the DTM 200, now optionally in an additional reviewing step a validation of this input value can be performed.

FIG. 3A shows the different software components installed in the host 107 for a solution of the state of the art, in the case of which the virtual keyboard is provided by the operating system. The operating system also processes the keyboard inputs of the user. As shown in FIG. 3A, the FDT-frame application 300 installed in the host includes an FDT user interface 301 and an FDT execution environment 302. The FDT user interface 301 is designed to provide a graphical user interface, via which the user 303 can communicate with the FDT-frame application 300. The FDT execution environment 302 serves, in contrast, for providing interfaces and for performing the communication with the different DTMs, which are integrated into the FDT frame application 300. The communication DTMs, gateway DTMs and device DTMs integratable into the FDT frame application 300 serve as drivers for their field devices and gateways of the fieldbus system.

In the case of the example shown in FIG. 3A, two different DTMs are integrated into the FDT frame application, wherein each of the DTMs has two parts. The first DTM includes a DTM user interface 304 as well as a DTM processing logic 305 arranged therebeneath. Likewise the second DTM includes a DTM user interface 306 as well as a DTM processing logic 307. The DTM user interfaces 304, 306 are embodied e.g., in each case, to present a graphical user interface, via which the user 303 can access their field devices and gateways. The actual driver functionality of the DTMs resides, in contrast, in each case, in the associated DTM processing logic 305, 307.

The processing of inputs of the user 303 as well as interactions of the user 303 with the FDT user interface 301 and the DTM user interfaces 304, 306 is conducted by the operating system 308 of the host 107. For this, the operating system 308 includes installed in the host 107 an input processing layer 309 as well as an interaction processing layer 310, which are arranged above the FDT user interface 301 and the DTM user interfaces 304, 306. Moreover, the operating system 308 includes a hardware abstraction layer 311, which, for example, provides various hardware drivers. Thus, the operating system 308 shown in FIG. 3A has a horseshoe shape, because it, on the one hand, includes the input- and interaction processing layers 309, 310, and, on the other hand, also the hardware abstraction layer 311.

FIG. 3B shows how the keyboard application 204 of the invention present in the case of the forms of embodiment of the present invention is added to the software components present in the host 107. In such case, equal or functionally similar components are provided in FIG. 3B with the same reference characters as in FIG. 3A. FIG. 3B shows that the keyboard application 204 is embodied as a part of the FDT frame application, and, indeed, as a part of the FDT user interface 301. Moreover, the keyboard application 204 is located between the input processing- and interaction processing layers 309, 310, on the one hand, and the DTM user interfaces 304, 306, on the other hand. In this way, it can be achieved that always when the user 303 taps on an input field, the operating system 308 calls the keyboard application 204 of the invention, which then is responsible for presenting a suitably matched, virtual keyboard and for processing the user input. Especially, the keyboard application 204 of the invention enables a continuous matching and updating of the presented, activated input keys to the required input formats, which preferably are predetermined by means of regular expressions.

FIG. 4 shows an overview of the entire course of the communication in the case of use of a keyboard application of the invention. Participating in this communication are the user 303, the keyboard application 204, the DTM user interface 304 and the DTM processing logic 305.

In the first step 400, the user 303 taps an input field of the DTM user interface 304. In step 401, the keyboard application 204 is informed of the event that an input field of the DTM user interface 304 was tapped. Following thereon, in step 402, the keyboard application 204 checks whether the DTM user interface 304 provides information concerning the type of inputs expected in the input field. When that is the case, the keyboard application 204 of the DTM frame application 300 fetches from the DTM user interface 304 semantic information concerning type, format and value range of the inputs expected in the input field. In the present case, the keyboard application 204 would obtain the information that a numerical input in a specific format is expected. The keyboard application 204 of the FDT frame application 300 then shows the user 303 in step 403 a keyboard in the form of a numerical keypad. The user 303 then in step 404 taps the digit “1” on the numerical keyboard, so that the digit “1” is registered by the keyboard application 204. In the step 405 following thereon, the keyboard application 204 transmits the registered input (digit “1”) to the DTM user interface 304, which displays this input in the input field.

The user confirms its input and activates therewith step 406. In step 406, the DTM user interface 304 forwards the obtained input to the DTM processing logic 305 together with the request to check the value range. The DTM processing logic 305 checks whether the input is located within the predetermined value range limits. In step 407, the DTM processing logic 305 confirms to the DTM user interface 304 that the input lies in the allowable range, and in step 408 the DTM user interface 304 confirms to the user 303 that its input has been accepted.

1-17. (canceled)

18. A method for registering an input into a user interface of a driver, comprising:
when a user selects an input field of the user interface of the driver, transferring from the driver to a keyboard application information concerning a type of input required by the input field;
matching a virtual keyboard displayed by the keyboard application to the information transferred from the driver concerning the type of input required; and
registering the input of the user,
wherein the driver is integrated into a device access software with which components of a fieldbus system can be accessed,
wherein the device access software includes the keyboard application, and
wherein the keyboard application is configured to display the virtual keyboard.

19. The method as claimed in claim 18, wherein the information concerning the type of input required includes at least one of the following: a format of the input required, a type of the input required, and a value range of the input required.

20. The method as claimed in claim 18, wherein the information concerning the type of input required is transferred from the driver to the keyboard application in the form of a regular expression, or
wherein the information concerning the type of input required is transferred from the driver to the keyboard application as a regular expression that includes specifications for a format of the input, allowed value ranges, and an expected separator.

21. The method as claimed in claim 18, wherein the transfer of the information concerning the type of input required includes transferring from the driver to the keyboard application a pointer that points to a data structure containing the information concerning the type of input required.

22. The method as claimed in claim 19, wherein the virtual keyboard displayed by the keyboard application includes a selection of actuatable input keys that are selected as a function of the type of the input required.

23. The method as claimed in claim 18, wherein
the virtual keyboard is matched in the continuing course of the input, in an ongoing manner, to the input values required at a particular input position or
the virtual keyboard is matched in the course of the input, in an ongoing manner, by a fading in and out of actuatable input keys for the input values required at the particular input position.

24. The method as claimed in claim 18, further comprising:
sending the input of the user from the keyboard application to the driver.

25. The method as claimed in claim 18, wherein the device access software is an FDT frame application, into which drivers of the standard, DTM, are integratable.

26. The method as claimed in claim 18, wherein drivers corresponding to one or more of the following standards are integratable into the device access software: DTM, DD, EDD, EDS, and FDI Device Packages.

27. The method as claimed in claim 18, wherein the keyboard application is implemented as a component of the device access software.

28. The method as claimed in claim 18, wherein a host in which the device access software is installed is at least one of the following: a mobile device, a mobile telephone, a tablet computer, a PDA, a computer, a laptop, a data eyeglasses, and a smart watch.

29. The method as claimed in claim 28, wherein
the host in which the device access software is installed includes a touch display or
the host in which the device access software is installed includes a touch display, wherein the keyboard application is configured to display the virtual keyboard on the touch display of the host, wherein the inputs into the user interface of the driver occur via the touch display.

30. A keyboard application for a device access software, wherein the keyboard application is designed to display a virtual keyboard and to register an input of a user into a user interface of a driver, wherein the driver is integrated into the device access software with which components of a fieldbus system can be accessed,
wherein the keyboard application is configured to receive from the driver information concerning a type of input required by an input field of the user interface of the driver when a user selects the input field of the user interface, to match the display of the virtual keyboard corresponding to the information received from the driver concerning the type of input required, and to register an input of the user.

31. The keyboard application as claimed in claim 30, wherein the information concerning the type of input required by the input field includes at least one of the following: a format of the input required, a type of the input required, and a value range of the input required.

32. The keyboard application as claimed in claim 30, wherein the virtual keyboard displayed by the keyboard application includes a selection of actuatable input keys that are selected as a function of the type of input required.

33. A device access software which is installed in a host and with which components of a fieldbus system can be accessed, comprising:
one or more drivers integrated into the device access software, wherein each driver is configured to access a component of the fieldbus system;
a keyboard application, wherein the keyboard application is designed to receive from the one or more drivers information concerning the type of input required by an input field of a user interface of the respective driver when a user selects the input field of the user interface of the respective driver, and to match a display of a virtual keyboard corresponding to the information obtained from the respective driver concerning the type of input required.

34. The device access software as claimed in claim 33, wherein the device access software is an FDT frame application into which drivers of the standard, DTM, are integratable.

35. The device access software as claimed in claim 33, wherein drivers corresponding to one or more the following standards are integratable into the device access software: DTM, DD, EDD, EDS, and FDI Device Packages.
